(19) United States
(12) Patent Application Publication
(10) Pub. No.: US 2014/0083494 A1
(43) Pub. Date: Mar. 27, 2014

(54) METHOD OF FORMING METAL OXIDE NANOTUBE AND DYE-SENSITIZED SOLAR CELL FORMED THEREBY

(71) Applicant: ELECTRONICS AND TELECOMMUNICATIONS RESEARCH INSTITUTE, Daejeon (KR)

(72) Inventors: Mi Hee JUNG, Daejeon (KR); Moo Jung Chu, Daejeon (KR); Mangu Kang, Daejeon (KR)

(73) Assignee: Electronics and Telecommunications Research Institute, Daejeon (KR)

(21) Appl. No.: 13/767,951

(22) Filed: Feb. 15, 2013

(30) Foreign Application Priority Data
Sep. 21, 2012 (KR) 10-2012-0105432

(51) Int. Cl. H01G 9/20; H01G 9/00

(52) U.S. Cl. CPC H01G 9/2031; H01G 9/0029; B82Y 40/00
USPC 136/256; 205/73; 977/890; 977/902; 977/700

(57) ABSTRACT

Provided are a method of forming metal oxide nanotube and a dye-sensitized solar cell formed thereby. The method may include providing a metal electrode and a counter electrode in an electrolyte containing a negatively polarized surfactant, and applying voltages to the metal electrode and the counter electrode to form a metal oxide nanotube on the metal electrode. The metal oxide nanotube may have a (001)-plane.

### CROSS-REFERENCE TO RELATED APPLICATIONS

This U.S. non-provisional patent application claims priority under 35 U.S.C. §119 to Korean Patent Application No. 10-2012-0105432, filed on Sep. 21, 2012, in the Korean Intellectual Property Office, the entire contents of which are hereby incorporated by reference.

### BACKGROUND OF THE INVENTION

Example embodiments of the inventive concept relate a method of forming metal oxide nanotube and a dye-sensitized solar cell formed thereby.

A dye-sensitized solar cell can be fabricated in a simplified process with a cheap material, and thus, it is considered one of next-generation solar energy technologies. However, the dye-sensitized solar cell suffers from low conversion efficiency of about 11%. To increase the conversion efficiency of the dye-sensitized solar cell, there have been proposed several methods for reducing an area of a photo electrode and improving a characteristic of photovoltage thereof. However, according to these methods, an adsorption amount of dye may be reduced, and thus, the dye-sensitized solar cell may suffer from a decrease in photocurrent.

### SUMMARY

Example embodiments of the inventive concept provide a metal oxide nanotube forming method capable of increasing efficiency of a solar cell.

Other example embodiments of the inventive concept provide a dye-sensitized solar cell with increased efficiency.

According to example embodiments of the inventive concepts, a method of forming a metal oxide nanotube may include providing a metal electrode and a counter electrode in an electrolyte containing a negatively polarized surfactant, and applying voltages to the metal electrode and the counter electrode to form a metal oxide nanotube on the metal electrode. The metal oxide nanotube may have a (001)-plane.

In example embodiments, the forming of the metal oxide nanotube may include adsorbing the surfactant onto the (101)-plane of the metal oxide layer applied with a positive voltage.

In example embodiments, the metal oxide nanotube may be formed by an anodic oxidation method.

In example embodiments, the anodic oxidation method may include applying positive and negative voltages to the metal electrode and the counter electrode, respectively to form positive metal ions on the metal electrode and oxygen ions in the electrolyte. The oxygen ions may be combined with the positive metal ions to form the metal oxide layer grown from a surface of the metal electrode.

In example embodiments, the negatively polarized surfactant may be polyvinyl pyrrolidone.

In example embodiments, the method may further include after the forming of the metal oxide nanotube on the metal electrode, removing the electrolyte, annealing the metal oxide nanotube to remove the surfactant, and separating the metal oxide nanotube from the metal electrode.

According to example embodiments of the inventive concepts, a dye-sensitized solar cell may include a top substrate and a bottom substrate spaced apart from each other, a lower electrode provided on a top surface of the bottom substrate, a semiconductor electrode layer provided on the lower electrode, an upper electrode provided on the top substrate, and an electrolyte solution layer provided between the lower electrode and the upper electrode. The semiconductor electrode layer may include metal oxide nanotubes having (001)-plane.

In example embodiments, metal oxide nanotubes may be single crystalline TiO2 nanotubes.

In example embodiments, the metal oxide nanotubes may be in contact with a top surface of the lower electrode, have a longitudinal axis perpendicular to the top surface of the lower electrode, and may be arranged horizontally on the top surface of the lower electrode.

In example embodiments, the dye-sensitized solar cell may further include dyes surrounding the metal oxide nanotubes.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIGS. 1A and 1B are a perspective view illustrating a face-centered cubic (FCC) crystal structure and a graph illustrating XRD diffraction pattern of a titanium oxide (TiO₂) layer.

FIG. 2 is a flow chart illustrating a process of forming a metal oxide nanotube according to example embodiments of the inventive concept.

FIG. 3 is a sectional view illustrating a mixture of an electrolyte and polyvinyl pyrrolidone according to example embodiments of the inventive concept.

FIG. 4 is a schematic diagram illustrating an anodic oxidation method according to example embodiments of the inventive concept.

FIG. 5 is a perspective view of titanium oxide nanotubes according to example embodiments of the inventive concept.

FIG. 6 is a sectional view of a dye-sensitized solar cell according to example embodiments of the inventive concept.

FIGS. 7A and 7B are scanning electron microscope (SEM) and transmission electron microscope (TEM) images of titanium oxide nanotubes according to example embodiments of the inventive concept.

FIGS. 8A and 8B are X-ray diffraction (XRD) graphs of titanium oxide nanotubes according to example embodiments of the inventive concept.

FIG. 9 is a graph showing I-V curves measured from a dye-sensitized solar cell, in which titanium oxide nanotubes with (001)-plane according to example embodiments of the inventive concept are provided.

FIG. 10 is a table showing a relation between a surface area of titanium oxide nanotubes according to example embodiments of the inventive concept and an amount of dye adsorbed thereon.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

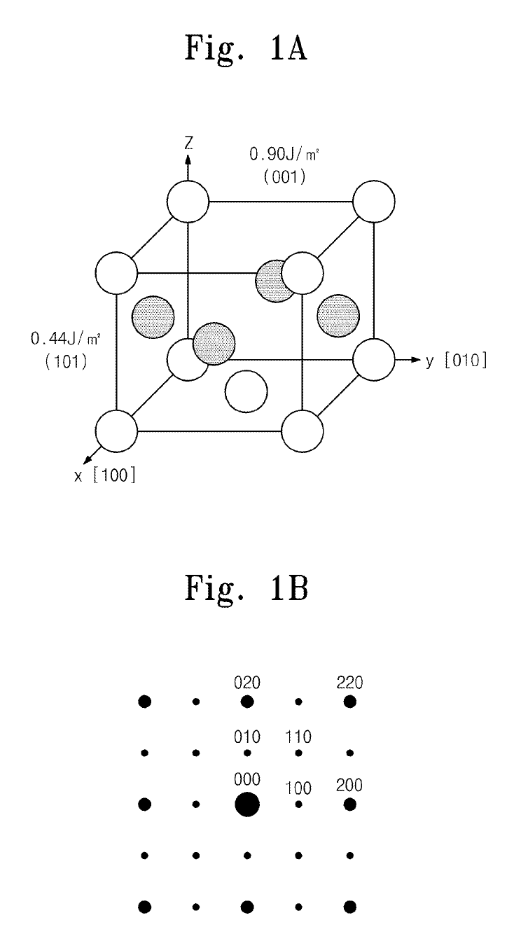

FIGS. 1A and 1B are a perspective view illustrating a face-centered cubic (FCC) crystal structure and a graph illustrating XRD diffraction pattern of a titanium oxide (TiO2) layer.

Referring to FIG. 1A, in the FCC structure, atoms are arranged at the corners and center of each cube face of the cell. In the face-centered cubic, (101)-plane has a surface energy of 0.44 J/m² and (001)-plane has a surface energy of 0.9 J/m²; that is, the surface energy is greater on (001)-plane than on (101)-plane. Due to this difference in surface energy, the (001)-plane has lower stability and greater reactivity than those of the (101)-plane.

Referring to FIG. 1B, spots show crystal planes of titanium oxide. For example, the more the spots, the more the crystal planes of titanium oxide. As shown in FIG. 1B, the titanium oxide may have at least (010), (110), and (100) planes.

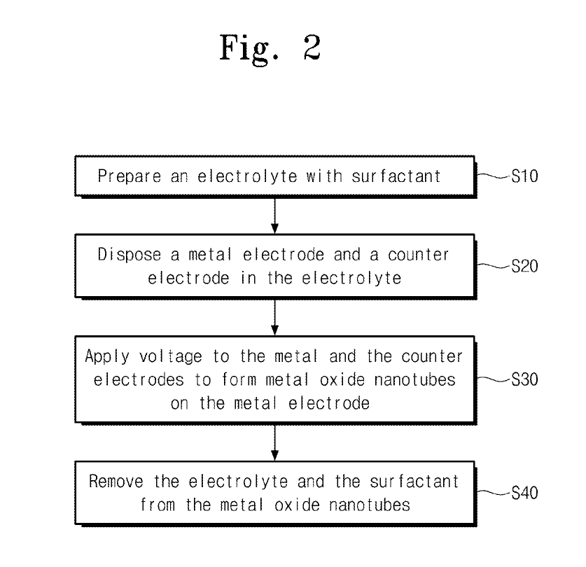

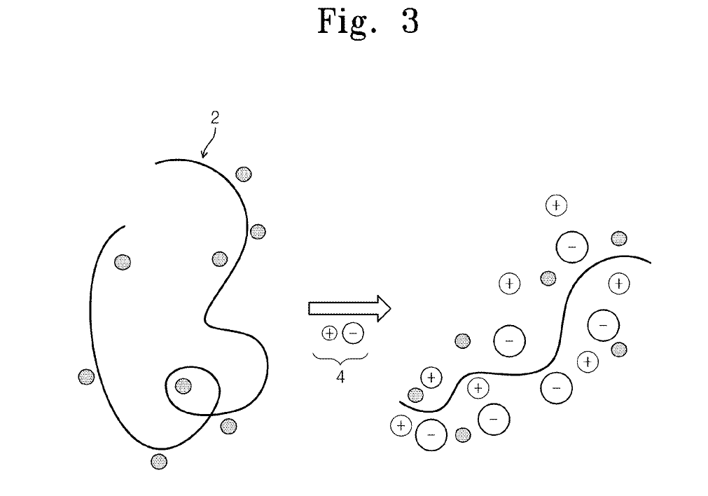

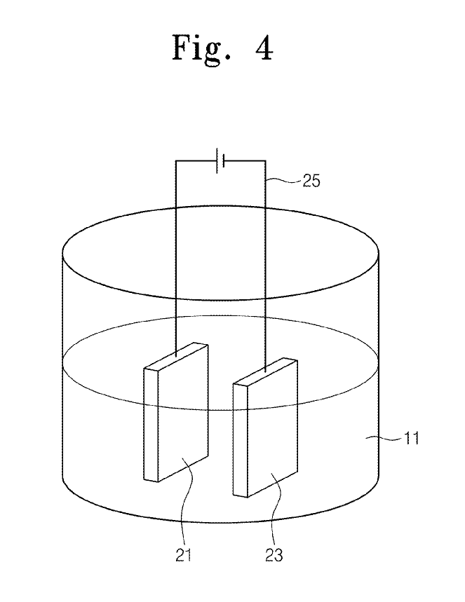

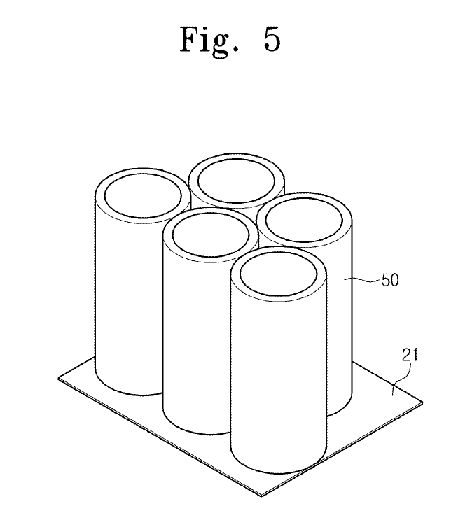

FIG. 2 is a flow chart illustrating a process of forming a metal oxide nanotube according to example embodiments of the inventive concept. FIG. 3 is a schematic diagram illustrating a mixture of an electrolyte and polyvinyl pyrrolidone according to example embodiments of the inventive concept. FIG. 4 is a schematic diagram illustrating an anodic oxidation method according to example embodiments of the inventive concept. FIG. 5 is a perspective view of titanium oxide nanotubes according to example embodiments of the inventive concept.

Referring to FIG. 2, prepared is an electrolyte with surfactant (in S10)

The surfactant may be dissolved into the electrolyte. The electrolyte may be prepared by adding ammonium fluoride (NH₄F) and water (H₂O) in ethylene glycol solution. In example embodiments, the ammonium fluoride (NH₄F) of 0.25 wt % and the water (H₂O) of 0.75 wt % may be added into the electrolyte. The surfactant may be a polymer with negative polarity. For example, the surfactant may be polyvinyl pyrrolidone. An acetic acid may be added during adding the surfactant into the electrolyte. In example embodiments, polyvinyl pyrrolidone of 2 wt % and the acetic acid of 0.1M concentration may be added into the electrolyte. The electrolyte may be heated to about 160° C. to melt the polyvinyl pyrrolidone completely into the electrolyte. Referring to FIG. 3, polyvinyl pyrrolidone 2 may be mixed with and dissolved into electrolyte ions 4 contained in the electrolyte, such that the electrolyte ions 4 may be adsorbed onto a surface of the polyvinyl pyrrolidone 2.

A metal electrode and a counter electrode may be disposed in the electrolyte (in S20).

The metal electrode may serve as a template for forming the metal oxide nanotube. The metal electrode may include at least one of a titanium layer, a zinc layer, a tin layer, a tungsten layer, a strontium layer, or a zirconium layer. The counter electrode may include a platinum layer. The metal electrode and the counter electrode may be connected to a power supply. In example embodiments, the metal electrode may be a titanium layer.

The metal electrode and the counter electrode may be applied with voltages to form metal oxide nanotubes on the metal electrode (in S30).

For example, the metal oxide nanotube may be formed using an anodic oxidation method. Referring to FIG. 4, in the anodic oxidation method, oxygen ions in an electrolyte 11 may be combined with positive metal ions, which may be generated by applying a positive voltage to a metal electrode 21, and form a metal oxide layer on a surface of the metal electrode. The power supply 25 may apply a positive voltage to the metal electrode 21 and a negative voltage to the counter electrode 23. For example, the power supply 25 may be operated in such a way that a constant electric current and an AC voltage of about 30V-60V may be applied to the electrodes for about 2-10 hours. Positive metal ions (e.g., Ti⁴⁺) formed on the metal electrode 21 and oxygen ions (O²⁻) supplied from the electrolyte 11 may be combined to form a metal oxide (e.g., TiO₂) on the metal electrode 21 applied with the positive voltage. The metal oxide may be partially dissolved to form small holes in a portion of the metal oxide. As an intensity of an applied electric field is increased, a size of the small holes may also be increased to form pores having a size greater than that of the hole. Voids, which are smaller than the pores, may be formed between the pores, and the voids and the pores may be grown in the same manner. As a result, metal oxide nanotubes may be formed. During the formation of the metal oxide nanotubes, the negatively-charged polyvinyl pyrrolidone may be adsorbed on a (101)-plane of the positively-charged metal oxide nanotube. Accordingly, the polyvinyl pyrrolidone may occupy the (101)-plane of the metal oxide nanotubes, and thus, the metal oxide nanotubes may be grown on a (001)-plane. In other words, the metal oxide nanotubes with the (001)-plane may be formed. Referring to FIG. 5, an upper surface and a side of the metal oxide nanotubes 50 may be (001)-planes. That is, the metal oxide nanotubes 50 provided on the metal electrode 21 may be formed as a single crystal with the (001)-planes. Thus, the metal oxide nanotubes 50 may have a more smooth surface than a surface of a metal oxide nanotube composed of a number of metal particles.

The metal oxide nanotubes with (001)-plane may be formed by adsorbing the polarized polyvinyl pyrrolidone to (101)-plane of the metal oxide nanotubes having opposite polarization to the polyvinyl pyrrolidone. Since the (001)-plane has a surface energy higher than the (101)-plane, it may be used as a photocatalytic material with high reactivity or for a semiconductor electrode layer of the dye-sensitized solar cell to increase an adsorption amount of dye.

In the case where the metal oxide nanotube is used for the dye-sensitized solar cell, a (001) surface of the metal oxide nanotube may have an increased flatness compared with a polycrystalline surface of the metal oxide nanotube. Accordingly, it is possible to prevent an electron trapping phenomena from occurring, and thus, to improve electron mobility between the dye and the metal oxide electrode of the dye-sensitized solar cell.

After the formation of the metal oxide nanotube having the (001)-plane, the electrolyte and the surfactant may be removed from the metal oxide nanotubes (in S40).

The electrolyte may be removed by performing an ultrasonic treatment in deionized water and ethanol for one minute. After the removal of the electrolyte, an annealing process may be performed to the metal oxide nanotube. The annealing process may be performed in a furnace at a temperature or about 550° C. for 30 minutes. Accordingly, the adsorbed surfactant may be removed from the metal oxide nanotube, thereby facilitating recrystallization of the metal oxide nanotube. After the annealing process, the metal oxide nanotube may be digested in a hydrogen peroxide (H₂O₂) solution for one minute to separate it from the metal electrode.

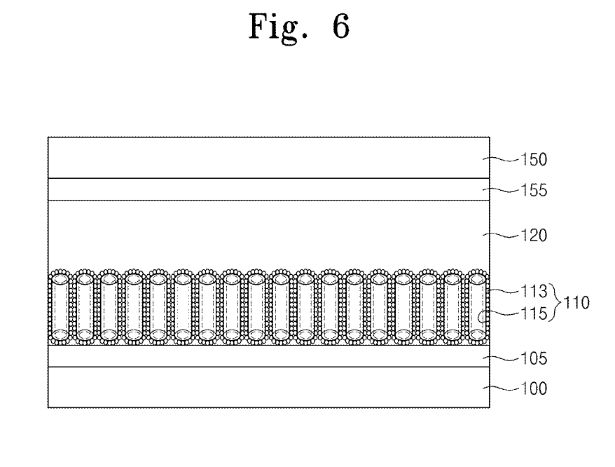

FIG. 6 is a sectional view of a dye-sensitized solar cell according to example embodiments of the inventive concept.

The dye-sensitized solar cell may include a bottom substrate 100 and a top substrate 150. The bottom substrate 100 may be provided spaced apart from the top substrate 150. A lower electrode 105 may be provided on a top surface of the bottom substrate 100, and an upper electrode 155 may be provided on a bottom surface of the top substrate 150. A semiconductor electrode layer 110 may be provided on a top surface of the lower electrode 105, and an electrolyte solution layer 120 may be provided between the semiconductor electrode layer 110 and the upper electrode 155.

The bottom substrate 100 may be a glass substrate or a transparent polymer substrate coated with a polymer layer. The lower electrode 105 may serve as a transparent electrode and include a conductive material. The conductive material for the lower electrode 105 may be formed of, for example, indium tin oxide (ITO), F-doped SnO₂ (FTO), ZnO, antimony tin oxide (ATO) or a carbon nanotube.

The semiconductor electrode layer 110 may include a metal oxide electrode layer and dye molecules 113. For example, the metal oxide electrode layer may include metal oxide nanotubes 115 with (001)-plane. The dye molecules 113 may be adsorbed onto surfaces of the metal oxide nanotubes 115. The metal oxide nanotubes 115 may be in contact with a top surface of the lower electrode 105 and have a longitudinal axis perpendicular to the top surface of the lower electrode 105. In addition, the metal oxide nanotubes 115 may be arranged horizontally on the top surface of the lower electrode 105. Each of the metal oxide nanotubes 115 may have a flat surface. The metal oxide nanotubes 115 may be formed of one of titanium oxide (TiO₂), zinc oxide (ZnO), tin oxide (SnO₂), tungsten oxide (WO₃), strontium oxide (SrO), and zirconium oxide (ZrO₂).

The dye molecules 113 may be a ruthenium-based dye material or a coumarin-based dye material. In the dye molecules 113, a light energy may be converted into an electric energy.

The top substrate 150 may be a glass substrate or a transparent polymer substrate coated with a polymer layer. The upper electrode 155 may further include a catalyst layer. The catalyst layer may include platinum (Pt), gold (Au), ruthenium (Ru), or carbon nanotubes.

The electrolyte solution layer 120 provided between the upper electrode 155 and the semiconductor electrode layer 110 may include a redox iodide electrolyte. For example, the electrolyte solution layer 120 may be I₃⁻/I⁻ electrolyte solution layer, which may be prepared by dissolving 0.7M 1-vinyl-3-methyloctyl-immidazoliuim iodide, 0.1M LiI and 40 mM I₂ into 3-methoxypropionitrile. Alternatively, the electrolyte solution layer 120 may be an acetonitrile solution containing 0.6M butylmethylimidazolium, 0.02M I2, 0.1M Guanidinium thiocyanate, and 0.5M 4-tert-butylpyridine.

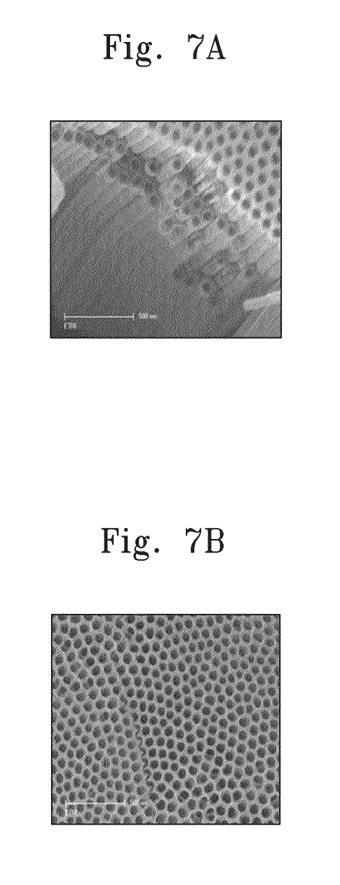

FIGS. 7A and 7B are scanning electron microscope (SEM) and transmission electron microscope (TEM) images of titanium oxide nanotubes according to example embodiments of the inventive concept.

As shown in FIGS. 7A and 7B, titanium oxide nanotubes were grown along a specific direction and have pores having a substantially uniform width.

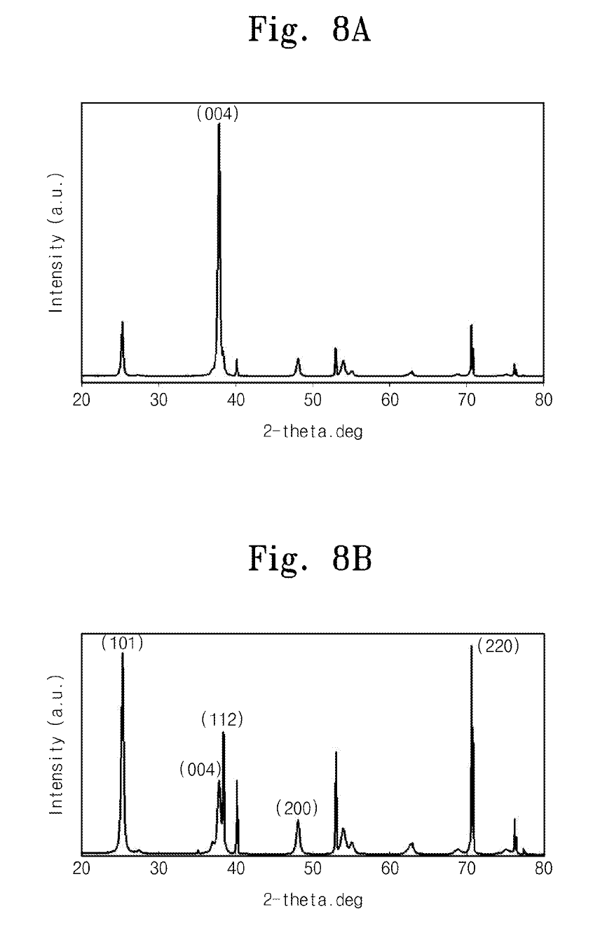

FIGS. 8A and 8B are X-ray diffraction (XRD) graphs of titanium oxide nanotubes according to example embodiments of the inventive concept.

In detail, FIG. 8A is an XRD graph measured from titanium oxide nanotube that was formed using polyvinyl pyrrolidone, while FIG. 8B is an XRD graph measured from titanium oxide nanotube that was formed without using polyvinyl pyrrolidone.

In the case that polyvinyl pyrrolidone was used, an intensity of X-ray diffraction had a peak at (004) plane as shown in FIG. 8A, while in the case that polyvinyl pyrrolidone was not used, intensities of X-ray diffraction from (101), (004), (112), (200), and (220) planes were similar to each other as shown in FIG. 8B. From comparison between FIGS. 8A and 8B, it can be said that the use of polyvinyl pyrrolidone can contribute to form the titanium oxide nanotube having a plurality of (001)-planes that has high reactivity.

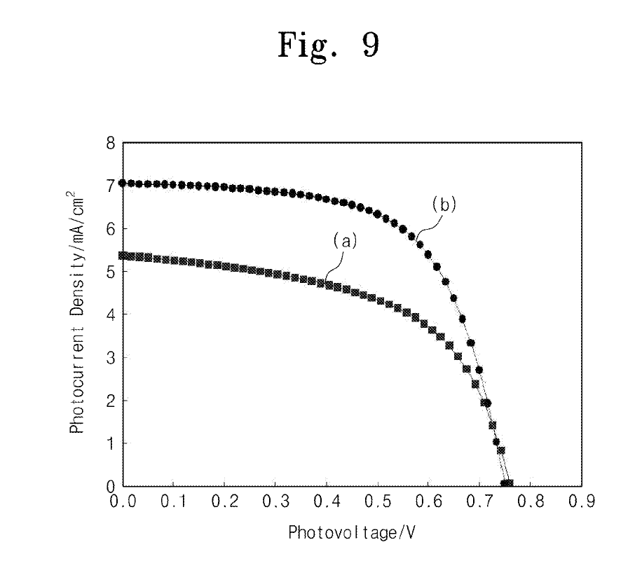

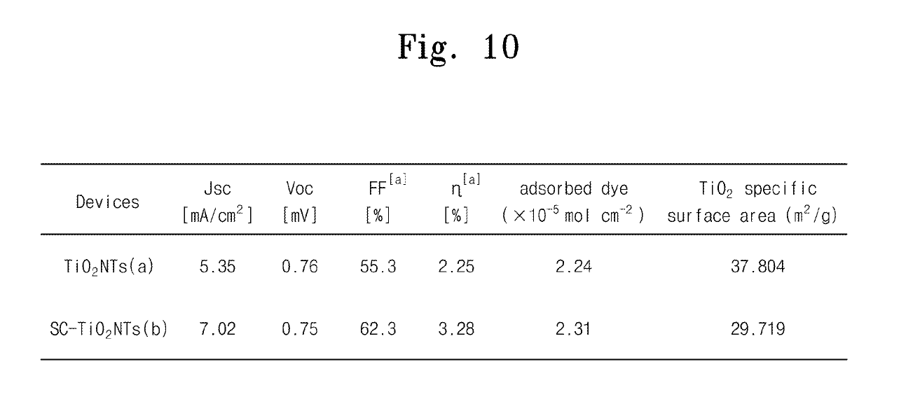

FIG. 9 is a graph showing I-V curves measured from a dye-sensitized solar cell, in which titanium oxide nanotubes with (001)-plane according to example embodiments of the inventive concept are provided. FIG. 10 is a table showing a relation between a surface area of titanium oxide nanotubes according to example embodiments of the inventive concept and an amount of dye adsorbed thereon.

In FIGS. 9 and 10, a curve or row denoted by a reference character of (a) shows I-V characteristics of a dye-sensitized solar cell, in which a semiconductor electrode layer formed using a titanium oxide nanotube with a polycrystalline surface was provided, while a curve or row denoted by a reference character of (b) shows I-V characteristics of a dye-sensitized solar cell, in which a semiconductor electrode layer formed using a titanium oxide nanotube with a (001)-plane was provided.

Referring to FIG. 9, at the same voltage of 0V, the curve (a) was 5.35 mA/cm², and the curve (b) was 7.02 mA/cm². This result shows that the use of the titanium oxide nanotube with a (001)-plane enables to increase a photocurrent of a dye-sensitized solar cell, compared with the case that the titanium oxide nanotube with a polycrystalline surface is used to form the semiconductor electrode layer of the dye-sensitized solar cell.

In addition, as shown in FIG. 10, the device of (a) had efficiency of 2.25%, while the device of (b) had efficiency of 3.28%. That is, the device of (b) had device efficiency higher by 1.03% than the device of (a). Further, the device of (b) had a surface area smaller than the device of (a), the device of (a) was higher than the device of (b) in terms of an amount of adsorbed dye per a surface area.

According to example embodiments of the inventive concept, metal oxide nanotubes may be formed by an anodic oxidation method adsorbing polyvinyl pyrrolidone onto a (101)-plane of a metal oxide layer that is grown from a surface of a metal electrode accordingly, the metal oxide nanotubes may have the (001)-plane. A surface energy of metal oxide nanotubes is higher on (001)-plane than on (101)-plane. Accordingly, metal oxide nanotubes (e.g., of TiO₂) with (001)-plane may be used as a photocatalytic material with high reactivity or for a semiconductor electrode layer of the dye-sensitized solar cell to increase an adsorption amount of dye. This enables to realize a dye-sensitized solar cell with improved efficiency.

In addition, the (001) surface of the metal oxide nanotube may have an increased flatness compared with a polycrystalline surface of the metal oxide nanotube, and thus, it is possible to prevent an electron trapping phenomena from occurring, and thus, to improve electron mobility between the dye and the metal oxide electrode of the dye-sensitized solar cell.

While example embodiments of the inventive concepts have been particularly shown and described, it will be understood by one of ordinary skill in the art that variations in form and detail may be made therein without departing from the spirit and scope of the attached claims.

What is claimed is:

1. A method of forming a metal oxide nanotube, comprising:
providing a metal electrode and a counter electrode in an electrolyte containing a negatively polarized surfactant; and
applying voltages to the metal electrode and the counter electrode to form a metal oxide nanotube on the metal electrode,
wherein the metal oxide nanotube has a (001)-plane.

2. The method of claim 1, wherein the forming of the metal oxide nanotube comprises adsorbing the surfactant onto the (101)-plane of the metal oxide layer applied with a positive voltage.

3. The method of claim 1, wherein the metal oxide nanotube is formed by an anodic oxidation method.

4. The method of claim 3, wherein the anodic oxidation method comprises applying positive and negative voltages to the metal electrode and the counter electrode, respectively to form positive metal ions on the metal electrode and oxygen ions in the electrolyte,
wherein the oxygen ions are combined with the positive metal ions to form the metal oxide layer grown from a surface of the metal electrode.

5. The method of claim 1, wherein the negatively polarized surfactant is polyvinyl pyrrolidone.

6. The method of claim 1, further comprising, after the forming of the metal oxide nanotube on the metal electrode,
removing the electrolyte;
annealing the metal oxide nanotube to remove the surfactant; and
separating the metal oxide nanotube from the metal electrode.

7. A dye-sensitized solar cell, comprising:
a top substrate and a bottom substrate spaced apart from each other;
a lower electrode provided on a top surface of the bottom substrate;
a semiconductor electrode layer provided on the lower electrode;
an upper electrode provided on the top substrate; and
an electrolyte solution layer provided between the lower electrode and the upper electrode,
wherein the semiconductor electrode layer comprises metal oxide nanotubes having a (001)-plane.

8. The dye-sensitized solar cell of claim 7, wherein the metal oxide nanotubes are in contact with a top surface of the lower electrode, have a longitudinal axis perpendicular to the top surface of the lower electrode, and are arranged horizontally on the top surface of the lower electrode.

9. The dye-sensitized solar cell of claim 7, wherein the metal oxide nanotubes are single crystalline TiO₂ nanotubes.

10. The dye-sensitized solar cell of claim 7, further comprising, dyes surrounding the metal oxide nanotubes.
